(19) United States
(12) Patent Application Publication
(10) Pub. No.: US 2026/0230692 A1
(43) Pub. Date: Aug. 6, 2026

(54) MODULAR IMAGING PLATFORM FOR PRECLINICAL OPTICAL IMAGING USING A MULTI-APERTURE METHOD AND STRAY-LIGHT COLLIMATOR

(71) Applicants: Alexander Klose, New York, NY (US); Neal Paragas, Seattle, WA (US)

(72) Inventors: Alexander Klose, New York, NY (US); Neal Paragas, Seattle, WA (US)

(21) Appl. No.: 19/456,388

(22) Filed: Jan. 22, 2026

Related U.S. Application Data
(60) Provisional application No. 63/748,089, filed on Jan. 22, 2025.

(51) Int. Cl. H04N 23/51; A61D 3/00; H04N 23/55; H04N 23/667

(52) U.S. Cl. CPC H04N 23/51; A61D 3/00; H04N 23/55; H04N 23/667

(57) ABSTRACT

The invention relates to a modular preclinical optical imaging platform designed for small animal models of human disease and tissue samples. The platform integrates advanced imaging modalities, including bioluminescence imaging (BLI), fluorescence imaging (FLI), and Cerenkov light imaging (CLI), along with their tomographic extensions. It generates quantitative planar and volumetric optical images for in vivo, in vitro, and ex vivo applications. The system addresses key challenges in preclinical optical imaging, such as limited photon detection, single-view limitations, surface-imaging constraints, absence of anatomical information, and semi-quantitative data analysis. To overcome these limitations, the platform incorporates innovative features, including a multi-aperture (MA) method for enhanced sensitivity, a stray-light collimator (SLC) for improved signal clarity, and a Body-Conforming Animal Mold (BCAM) paired with an Organ Probability Map (OPM) for instant anatomical co-registration without complex hardware.

### RELATED APPLICATIONS

This application claims the priority of U.S. Provisional Application No. 63/748,089, entitled “INVIVOSCAN-A MODULAR IMAGING PLATFORM FOR PRECLINICAL OPTICAL IMAGING USING A MULTI-APERTURE METHOD AND STRAY-LIGHT COLLIMATOR” filed on Jan. 22, 2025, the disclosure of which is hereby incorporated by reference in its entirety.

### FIELD OF THE INVENTION

The present invention pertains to the field of preclinical optical imaging of small animal models of human disease and tissue samples using optical reporter systems. A modular imaging platform utilizes an optical camera base and several interchangeable imaging modules with focus on a variety of imaging modalities. These modalities include bioluminescence imaging (BLI), fluorescence imaging (FLI), and Cerenkov light imaging (CLI) and their tomographic counterpart extensions. The imaging platform generates optical images, either as planar or volumetric images, that yield quantitative information about optical reporters in vivo, in vitro, or ex vivo.

### BACKGROUND OF THE INVENTION

Optical imaging is a non-invasive imaging modality for studying biological processes in small animal models of human disease longitudinally. Its wide spectrum of applications ranges from, for example, cancer and infectious disease research to neuroscience and research of gene expression. Different modes of optical imaging are differentiated according to their source of light generation and different pathways of image formation.

Different light sources can be bioluminescence, fluorescence, or Cerenkov sources, whereas images can be generated in two-dimensional (2D) and three-dimensional (3D) spatial dimensions of the imaged object. For example, bioluminescence light is produced by genetically engineered mice that have been modified to express light-emitting proteins (e.g., firefly luciferase), which function as a reporter (‘light beacon’) for the biological process being studied. In the presence of an exogenously administered substrate (e.g., luciferin), an enzymatic photochemical reaction induces the emission of light. The number of emitted photons per time (light intensity) is relatively small and, thus, highly sensitive optical cameras are required for detecting photons that exit the animal's surface.

Because photons are multiply scattered inside tissue, only images of diffuse light distributions can directly be measured, which subsequently impedes the accurate quantification of the light emitting target. These planar or 2D optical images only show diffuse light intensity distributions on the object's surface, such as the animal surface. In addition, 3D optical images can indirectly be generated by using image reconstruction algorithms. 2D and 3D optical imaging have greatly contributed to the success story in preclinical imaging research.

In general, optical imaging systems consist of a light-tight imaging box, a sensitive camera and lens, a set of different bandpass filters, an imaging stage, gas anesthesia supply, and control and data analysis software. Despite the notable progress in research and development of optical imaging instrumentation, one of the primary challenges has been the task for creating entirely new systems with improved performance characteristics, including increased imaging sensitivity, multi-view imaging, instantaneous anatomical co-registration, reproducible image quantification, and reduced instrument acquisition costs, all aimed at expanding their accessibility to a broader research community. Preclinical optical imaging still grapples, however, with several challenges encompassing the following:

Limited Photon Detection: The detection of a small number of photons emitted by deep-seated or weak optical targets remains an exceedingly daunting task. For example, when studying the early stages of disease development, such as cancer or bacterial infection, the number of cancer cells or bacteria present may be relatively small, which leads to a low photon count. A similar problem arises in stem cell research, where the migration of optically labeled stem cells is tracked, resulting in a weak optical signal at early migration stages of only a few stem cells. Last, cells expressing an optical reporter may also have a lower viability or experience a limited substrate availability, both resulting in fewer cells capable of emitting sufficient light for detection.

Single-View Limitations: Single-view imaging, which captures images from a solitary perspective, often falls short in providing a comprehensive understanding of biological processes throughout the entire animal. For example, when monitoring the migration and distribution of optically labeled stem cells, cancer cells, different pathogens such as bacteria, optical-labeled drugs, or metastases within the entire animal body, single-view imaging is just unable to determine whether the cells are evenly distributed or clustered in specific regions.

Surface-Imaging Limitations: Optical imaging can only image light exiting the animal's tissue surface that originates from a source inside tissue. Because of the light scattering properties of tissue, the spatial distribution of the exiting light is rather diffusive depending on the depth of the source. Capturing diffuse light distributions poses challenges when attempting to precisely determine the location and emission strength of optical targets within three-dimensional tissue structures.

Absence of Anatomical Information: Like nuclear imaging, optical imaging does not provide any anatomical information, which makes it difficult to accurately identify the spatial location of an optical target relative to the animal's anatomy. For example, detecting the spread of metastases or the location of a bacterial infection involves identifying the affected tissues or organs.

Semi-Quantitative Analysis: Optical imaging is often seen as qualitative or semi-quantitative due to the scattered and partially absorbed light within tissue, resulting in diffuse surface distributions. Quantifying these distributions is challenging as it varies with the animal's size, pose, and location relative to the detector. The lack of standardization makes it difficult to compare data across different study time points or animals, hampering data reproducibility.

### SUMMARY OF THE INVENTION

A modular imaging platform for preclinical optical imaging addresses the shortcomings currently encountered in preclinical optical imaging. It is a compact table-top unit that comprises a camera base and multiple distinct detector head modules tailored for specific imaging applications, including planar high-throughput, 3D tomographic, and multi-view imaging. Because of its modular and compact design, it can be offered to customers at lower costs and, hence, provides a low-entry point to small animal imaging for a larger research community.

This platform utilizes an advantageous multi-aperture (MA) method and a unique stray-light collimator (SLC) to enhance optical imaging sensitivity and facilitates the volumetric reconstruction of bioluminescence or Cerenkov light sources inside tissue using the mathematical frameworks of multispectral Bioluminescence Tomography (BLT) and Cerenkov Light Tomography (CLT).

Complemented by a Body-Conforming Animal Mold (BCAM) and Organ Probability Map (OPM), the platform ensures instant anatomical co-registration of small animals without relying on complex hardware while fostering spatial data congruency and automated quantification across animals and imaging time points. This advantageous component enables precise co-registration across diverse modalities, encompassing 2D and 3D imaging modalities of different detector head modules, thereby enhancing the system's versatility and appeal.

The platform heralds a paradigm shift in preclinical optical imaging technology by seamlessly integrating multi-view imaging, instant anatomical co-registration, and automated data analysis, resulting in unparalleled 2D and 3D imaging performance. Unlike cumbersome ‘one-size-fits-all’ systems that attempt to juggle various imaging tasks within the same apparatus, the modular design of the platform excels in its simplicity, reducing system complexity while optimizing performance for specific tasks. By eliminating movable parts and intrinsic electronics like rotating cameras, movable mirrors, motorized imaging stages, and surface registration hardware, the system becomes streamlined, leading to both cost and complexity reductions. In other words, these parts may be in a fixed position. Researchers reap the benefits of system flexibility, tailoring it to their unique requirements, whether they need an entry-level setup or a high-performance/high-throughput configuration.

The modular and compact design not only enhances adaptability but also simplifies long-term maintenance. Malfunctioning modules or camera base units can be effortlessly replaced without requiring onsite technician support. This compact table-top system offers interchangeable detector head modules tailored for specific imaging tasks, such as planar high-throughput, 3D tomographic, and multi-view imaging. The platform delivers unparalleled imaging performance, streamlining multi-view imaging, anatomical co-registration, and automated data analysis.

In one embodiment, a platform for preclinical optical imaging may include an optically sealed container housing an optical camera, a fan, and a filter wheel with a plurality of bandpass filters. The platform may also include an interchangeable detector head module and a digital processing unit. The preclinical imaging device may include an imaging stage holding a plurality of imaging subjects and the interchangeable detector head module may have a single view base module having a planar mirror reflecting light into the optical camera. In one embodiment, the platform may also have an imaging stage holding a plurality of imaging subjects and the interchangeable detector head module includes a dual view base module may have at least two planar mirrors simultaneously capturing a dorsal view, a ventral view, a lateral left view and a lateral right view of the plurality of imaging subjects.

According to one implementation, the platform may be equipped with a body conforming animal mold holding each of the plurality of imaging subjects. An organ probability map may also be utilized in combination with the body conforming animal mold to achieve anatomical co-registration. In one implementation, the platform may include a multiple view base module having a plurality of apertures, the plurality of apertures proportionally improving a signal to noise ratio, a concentric planar mirror system, a stray-light collimator; and a body conforming animal mold. The plurality of apertures proportionally may improve the signal to noise ratio is improved by a factor of √N, where N is a numerical sum of the plurality of apertures. In one embodiment, the optical camera and concentric mirror system are in a fixed position. The concentric planar mirror system may have a plurality of segments wherein a number of segments increases the total light collection capability. In one implementation, the stray-light collimator is cylindrical in shape and reduces the amount of back-reflected light.

A method for preclinical optical imaging may perform the step of providing an optically sealed container housing an optical camera, a fan, and a filter wheel with a plurality of bandpass filters and providing an interchangeable detector head module. The method may also initialize a digital processing unit for performing imaging techniques of one or more imaging subjects and capturing an image of the imaging subject.

In one implementation, the preclinical imaging technique may include selecting a 2D imaging modality with a single view base module and performing the 2D imaging modality with the single view base module. In another implementation, the preclinical imaging technique may include selecting a 3D imaging modality with a single view base module and performing the 3D imaging modality with the single view base module. The method may also include selecting, via the digital processing unit, an imaging mode from a plurality of imaging modes. The imaging modes may include, but are not limited to, bioluminescence imaging (BLI), fluorescence imaging (FLI), and Cerenkov light imaging (CLI). The method may also include configuring a mirror system to capture a plurality of views of an imaging subject, increasing a total aperture by combining a plurality of apertures, and enhancing imaging sensitivity with a stray light collimator.

In one embodiment, the method may present a user interface on a device providing for engagement with interchangeable detector head module. This method may further provide for reconstructing a 3D spatial distribution of one or more optical reporters with a multispectral optical tomography technique. In one embodiment, the multispectral optical tomography technique is bioluminescence tomography and/or Cerenkov light tomography.

Additional aspects of the present invention will be apparent in view of the description which follows.

### BRIEF DESCRIPTION OF THE FIGURES

FIG. 1 illustrates a schematic of the modular imaging platform;

FIG. 2a illustrates a modular imaging platform;

FIG. 2b illustrates a modular imaging platform in a variety of configurations;

FIG. 3a illustrates a schematic of a single aperture imaging method;

FIG. 3b illustrates a schematic of a multi-aperture imaging method;

FIG. 3c illustrates a mirror system providing a plurality of view for a subject;

FIG. 4 a illustrates a mirror system with N segments for light collection;

FIG. 4b illustrates a schematic of a Stray-Light Collimator (SLC) for reduction of back-reflected light;

FIG. 5a illustrates a body conforming animal mold and corresponding mirror system providing multiple views of a subject;

FIG. 5b illustrates an output of an optical ray-tracing simulation;

FIG. 5c illustrates a graph showing stray light being reflect onto the body conforming animal mold surface;

FIG. 6a illustrates an image generated by a multi-aperture imaging platform;

FIG. 6b illustrates an image generated by a single-aperture imaging platform;

FIG. 6c illustrates an image generated by a multi-aperture imaging platform;

FIG. 6d illustrates a graph of signal to noise efficiency for a multi-aperture imaging platform;

FIG. 6e illustrates a graph comparing single aperture and multi-aperture imaging platforms;

FIG. 7 illustrates an image captured by a multi-aperture imaging platform;

FIG. 8a illustrates a standard image captured by a multi-aperture imaging platform;

FIG. 8b illustrates an image captured by a multi-aperture imaging platform with a stray-light collimator;

FIG. 8c illustrates a graph comparing photon counts in a platform without a collimator and a platform with a collimator; and

FIG. 9 illustrates a network diagram of the platform for preclinical optical imaging.

### DETAILED DESCRIPTION OF THE INVENTION

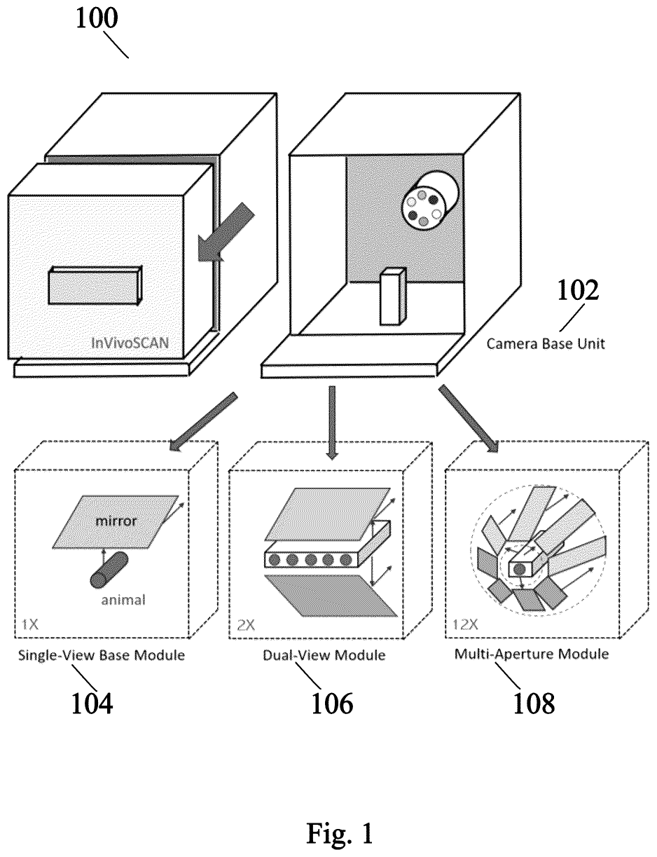

FIG. 1 illustrates a schematic of the modular imaging platform. The modular imaging platform 100 includes a camera base unit 102 and three or more interchangeable detector head modules (left to right): 1×, 2×, and 12×. In one embodiment, the three interchangeable detector head modules include a single view base module 104, a dual view base module 106 and a multi-aperture view base module 108. The interchangeable detector head modules are light-tight boxes, may be attached to the camera base via a manual lock-in mechanism, and can selectively be used either for bioluminescence, fluorescence, or Cerenkov light imaging.

The camera base features a light-tight box, a cooled optical camera (e.g., CCD, sCMOS, or EMCCD), a large-aperture lens (e.g., f/0.95-f/2), a filter wheel with bandpass filters (e.g., eight bandpass filters between 560 nm and 700 with 20 nm bandwidth), a webcam for animal monitoring, a hot-air fan with temperature control, gas anesthesia supply, and a digital processing unit (MicroPC) with external display. The platform may include three or more different detector head modules for BLI.

‘1×’ Single-View Base Module: Designed for standard planar imaging (BLI and CLI), it incorporates an imaging stage for holding up to 10 animals or other optical probes (e.g., tissue samples, well-plates) and a single planar mirror for reflecting light into the camera. ‘2×’ Dual-View Module: Ideal for high-throughput optical imaging of up to five animals, this module features two planar mirrors that simultaneously capture dorsal/ventral or lateral left/right views of animals inside an animal shuttle (e.g., BCAM). It corrects light intensities as far lateral sections of the animal, enhancing imaging accuracy. The BCAM supports anatomical co-registration using the OPM which provides a detailed anatomical map for enhanced precision.

‘12×’ Multi-Aperture Module: Engineered for high-sensitivity optical imaging and tomography (BLI or CLI and for BLT or CLT), this module includes a concentric planar mirror system with a stray-light collimator and BCAM. It facilitates 3D tomographic imaging and provides a full view of the entire optical light distribution around and sources inside the animal. The BCAM supports anatomical co-registration using the OPM which provides a detailed anatomical map for enhanced precision.

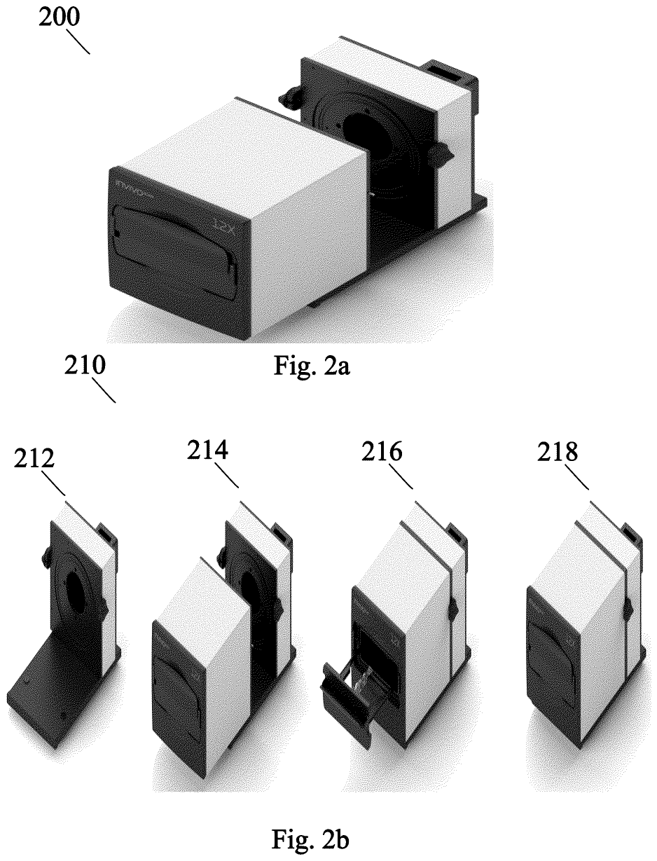

FIG. 2a illustrates a modular imaging platform. FIG. 2a shows the modular imaging platform 200 consisting of the camera base module and a detector head module. FIG. 2a shows the camera base module, attached to a stationary platform, and a removable detector head module.

FIG. 2b illustrates a modular imaging platform in a variety of configurations. The modular imaging platform 210 shows the stand alone base module 212. FIG. 2b further illustrates a detector head module being initially introduced to base 214. The detector head module may be also viewed in a fully attached position with the base 216 with a door or tray in an open position. The modular imaging platform is also shown in the fully closed configuration 218.

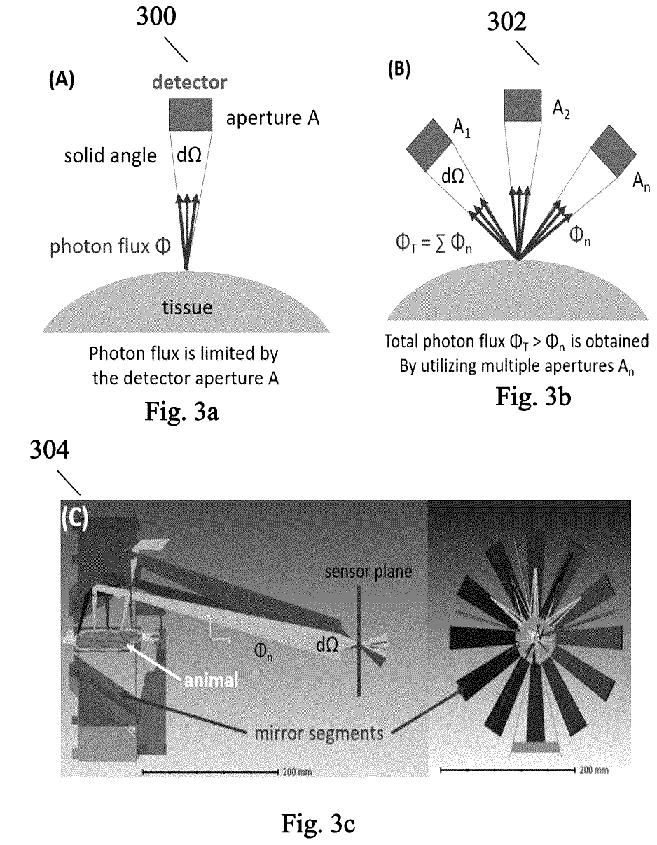

FIG. 3a-c shows three schematics of the state-of-the-art single aperture imaging approach (FIGS. 3A, 300), the proposed multi-aperture imaging method (FIGS. 3B, 302), and a mirror system providing multiple views of a single animal (FIGS. 3C, 304). The number of photons that are currently detected with optical systems at a single surface point of an animal constitutes only a fraction of all exiting photons, given by the photon flux Φ. This fraction depends on the limited lens aperture (A), object distance (r), and orientation of its solid angle (Ω) relative to the object surface (FIG. 3A).

Therefore, we devised the multi-aperture (MA) method that combines multiple apertures Aₙ to yield a larger total aperture A_{T}, which increases the total photon flux Φ_{T}>Φ beyond the light collection capabilities of a single lens aperture. The MA method collects photons at a surface point from N different views within the solid angle Ω, integrates the light intensity, and assigns it to the surface point (FIG. 3B). Considering photon shot noise (Poisson statistics), the improvement in SNR is directly proportional to the number of used apertures: SNR ~\sqrt{N}.

In this context, the light intensity signal is the total number of photons collected from a given surface point of the animal, and the dominant noise source is photon shot noise, which follows Poisson statistics. For a single aperture, the expected signal scales with the photon flux Φ, while the noise scales with the square root of that flux, √Φ. Thus, the signal-to-noise ratio (SNR) scales with SNR ∝Φ/√Φ=√Φ. Therefore, an improvement in SNR can be achieved when the intensity values from multiple apertures are combined and assigned to the surface point, because its signal intensity is much larger than its noise component when compared to the single aperture case.

The multi-aperture (MA) method effectively increases the total collected photon flux by integrating light from N independent apertures observing the same surface point within the solid angle Ω. The signals from these apertures add linearly, yielding a total signal proportional to NΦ, while the shot noise contributions add in quadrature, yielding a total noise proportional to √(NΦ). As a result, the SNR improves by a factor of √N relative to a single aperture. Practically, this SNR improvement means higher radiometric precision, reduced intensity fluctuations, and improved robustness in downstream tasks such as surface reconstruction, depth estimation, or reflectance analysis—without requiring a single larger lens that may be physically or optically impractical.

Multiple views, i.e. apertures, can be achieved by multiple camera positions or by employing a mirror system with only a single camera (FIG. 3C). Secondly, multispectral optical tomography, e.g., BLT and CLT, reconstructs the 3D spatial distribution of optical reporters, i.e. bioluminescence or Cerenkov light reporters, inside the animal and, hence, overcomes the limitations of surface imaging and semi-quantification of planar optical imaging. The increased sensitivity and multiple views facilitate the application of tomographic approaches, which require a sequence of spectral images of the entire animal surface, limited by the camera exposure time and spectral bandwidth.

Multiple apertures increase the signal-to-noise ratio (SNR) of low-light spectral images taken with narrow-bandwidth filters and provide the entire surface light distribution across the entire animal surface. Next, a BCAM holds the animal in a spatially defined position and provides spatial data congruency across different animals, placing them in a similar pose and position that facilitates image quantification and reproducibility. Lastly, in combination with the BCAM, the OPM is a statistical mouse atlas and provides instantaneous anatomical co-registration without the need for elaborate spatial co-registration hardware or x-ray CT.

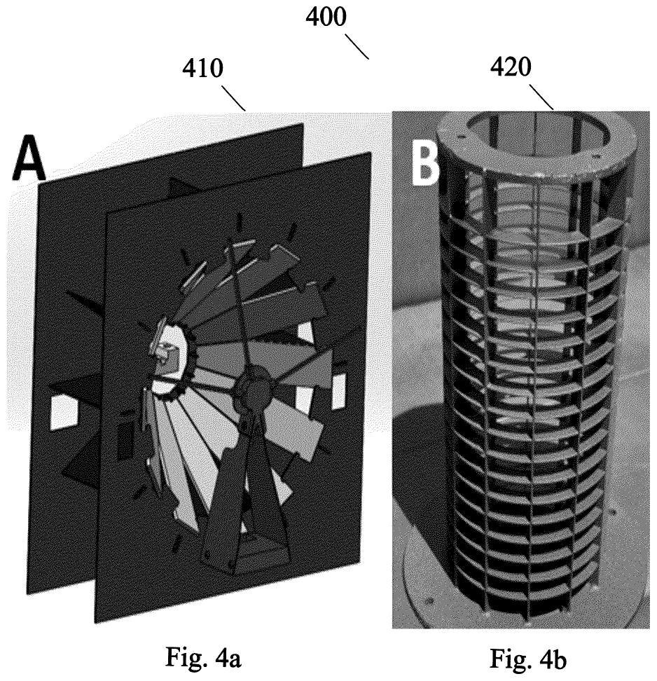

FIG. 4 shows two schematics of the MA hardware 400. FIG. 4A shows a mirror system 410 with N segments for light collection and Stray-Light Collimator (SLC) for reduction of back-reflected light (FIG. 4B). The MA method utilizes a concentric system of N planar mirrors to significantly boost the total light collection capabilities of the optical train shown in FIG. 4A. N/2 mirrors of the concentric system can collect photons from a single surface point within solid angles Ωₙ but from different viewing angles ωₙ. Combining all solid angles increases the total light collection capability or total aperture of the optical train by a factor N/2. Thus, it increases the SNR of the camera image by a factor N/\sqrt{2N}. For example, a twelve-mirror (12×) system increases the SNR by a factor of 2.4. In practice, the animal inside the optically transparent BCAM is placed in the center of the mirror system and without obstructing any view. Emitted light is reflected into the camera, while providing different views of the same surface point.

A back-projection algorithm maps the camera image back onto the BCAM while integrating the light intensities of each mirror segment for each surface point. The increased total flux and SNR enable imaging of smaller or deep-seated optical reporters and facilitates tomographic imaging with narrow bandpass filters. The mirror system also provides a complete 360° view of the entire animal surface. In comparison, most commercially available optical imaging systems for BLI or CLI only use a single view or solid angle, and their imaging sensitivity is solely dependent on the optical performance of camera and lens.

A stray light collimator (SLC) is an optical structure used to control the angular distribution of light entering an optical system, with the primary purpose of suppressing unwanted mirror back-reflection or stray illumination of the animal surface. Rather than forming an image or producing a perfectly parallel beam, the stray light collimator restricts the directions from which light may reach a detector, allowing primarily on-axis or near-axis rays to pass while blocking or absorbing off-axis, scattered, or reflected light. In this way, it improves signal-to-noise ratio, contrast, and measurement reliability.

Physically, a stray light collimator may take the form of a tubular channel, a series of apertures or baffles, a honeycomb structure, or a micro-collimator array positioned between the animal surface and the mirror or in front of a sensing element. The interior surfaces are typically treated to absorb light, ensuring that photons entering at improper angles are attenuated before reaching the sensing element. The structure may be purely mechanical or combined with simple optical elements, but it does not require precision lenses. In operation, the stray light collimator functions as an angular filter rather than a beam-forming optic. By defining a controlled acceptance cone for incoming light, it reduces flare, ghosting, and background contamination caused by reflections from surrounding structures or enclosures.

The SLC is a device that restricts the acceptance angle of emitted photons that strike the mirror surface and prevents photons from being reflected again to the animal surface. It reduces the amount of back-reflected light that could interfere with the measured optical signal. The cylindrical SLC consists of a stack of thin, black-coated metal rings, held together by vertical metal stripes. The BCAM with animal is placed inside the SLC. The ring dimensions are deliberately chosen according to the acceptance angle for photons striking the mirror into the camera, whereas back-reflected photons will be absorbed by the metal. The SLC eliminates the challenges of back-reflection encountered in mirror-based systems, specifically for conical mirror systems. It has been reported that conical mirrors can add up to 20% of the optical signal back to the animal surface and contribute to the total signal measured by the camera, while decreasing its SNR. Therefore, the proposed SLC can make mirror-based systems a viable solution for multi-view imaging.

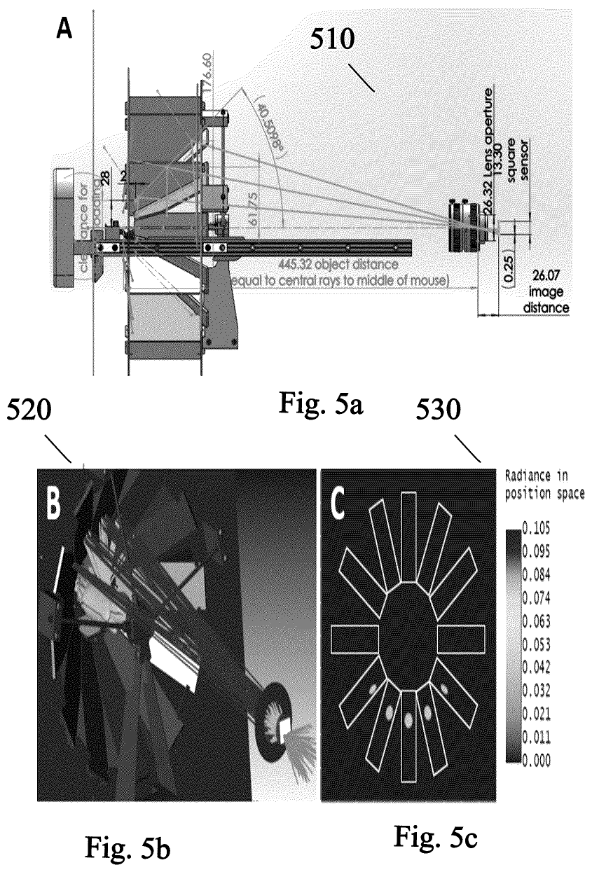

FIG. 5 illustrates a body conforming animal mold and corresponding mirror system providing multiple views of a subject. FIG. 5a illustrates a body conforming animal mold and corresponding mirror system providing multiple views of a subject. FIG. 5b illustrates an output of an optical ray-tracing simulation, FIG. 5c illustrates a graph showing stray light being reflected onto the body conforming animal mold surface.

The total light collection capabilities of a concentric mirror system and the impact of the SLC in reducing unwanted back-reflection is shown in FIG. 5. A CAD model of the basic optical components of the proposed imaging system is shown in FIG. 5. The model consists of the BCAM with adapter for secure placement, a gantry with 12 concentric planar mirror segments, an SLC, lens (f=25 mm, f/0.95), and a 13.4×13.4 mm² sensor area. Each of the 12 mirror segments had a size of 32 mm×140 mm, placed in a concentric arrangement (inner ø50 mm, outer ø250 mm, 45° mirror segment tilt) around the BCAM. The results of an optical ray-tracing simulation based on the CAD model are shown in FIG. 5B. A uniform Lambertian emitter (ø10 mm) and known intensity is placed at three different locations on the BCAM surface and calculated the amount of light that strikes the mirrors and is reflected onto the sensor (FIG. 5B). The amount of stray light being reflected onto the BCAM surface with or without collimator is shown in FIG. 5C.

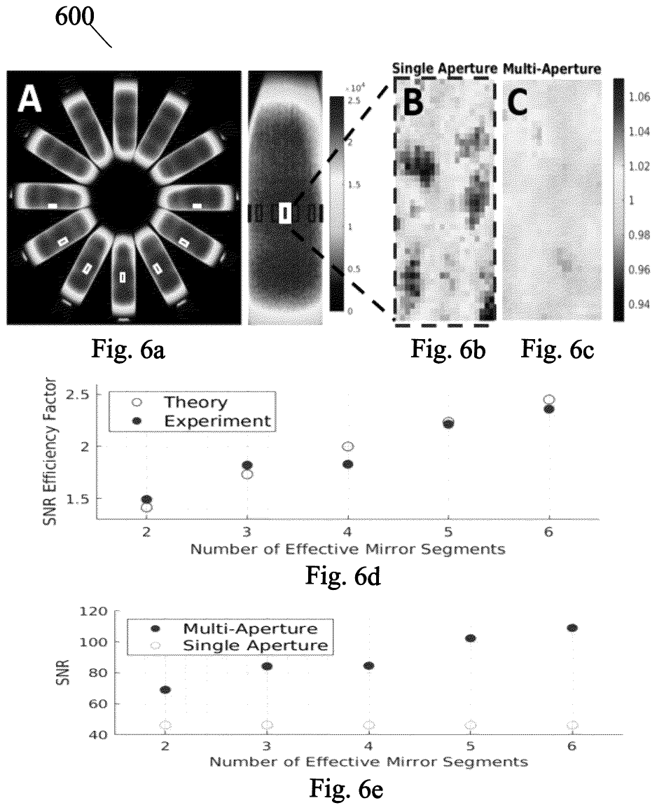

FIG. 6a illustrates an image generated by a multi-aperture imaging platform. FIG. 6b illustrates an image generated by a single-aperture imaging platform. FIG. 6c illustrates an image generated by a multi-aperture imaging platform. FIG. 6d illustrates a graph of signal to noise efficiency for a multi-aperture imaging platform. FIG. 6e illustrates a graph comparing single aperture and multi-aperture imaging platforms.

FIG. 6 shows an example demonstrating the feasibility of the multi-aperture method. FIG. 6 a shows a camera image of a 12× mirror gantry with a cylinder phantom placed inside at the center of the mirror system. FIG. 6b shows a single aperture image of the phantom area. FIG. 6c shows the multi-aperture image of the same area. FIG. 6d shows the improvement in SNR using multi-aperture method in comparison to the single aperture image as used in standard imaging. FIG. 6e shows a comparison of the SNRs of both methods.

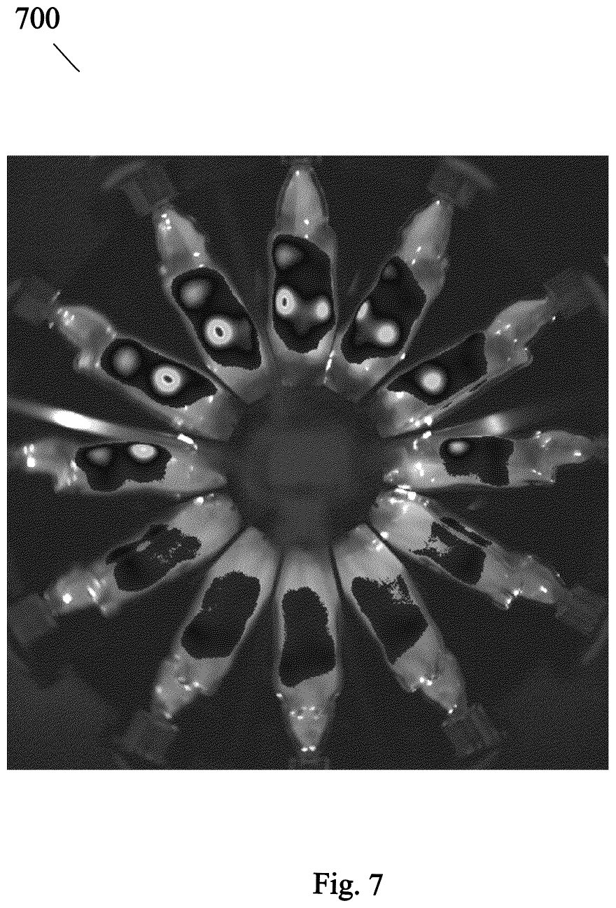

FIG. 7 illustrates an image captured by a multi-aperture imaging platform. FIG. 7 shows the ‘12×’ mirror system with a live animal placed inside the BCAM and in the center of the mirror system. The animal emits bioluminescence light that has been captured with a CCD camera. The figure shows the captured bioluminescence light overlayed on top of a grayscale photograph of the mirror system. Different spatial views of the BCAM and animal can be seen in the photograph.

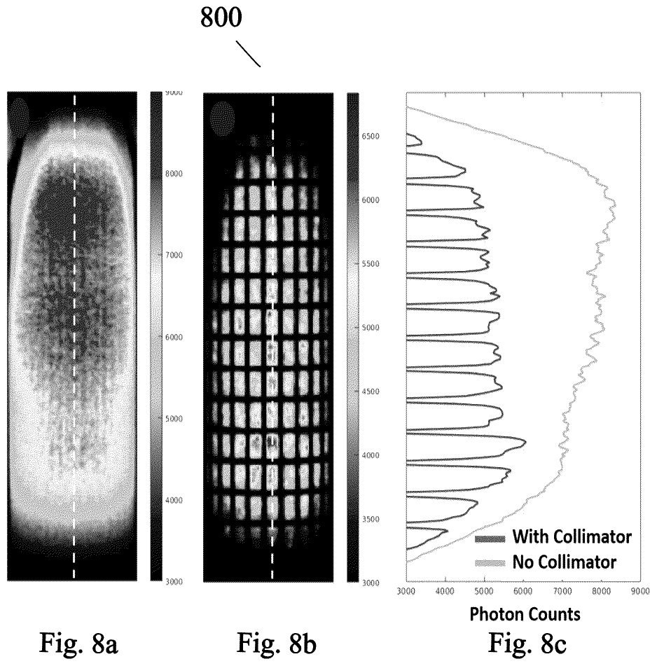

FIG. 8 illustrates a schematic of an optical ray tracing graph and a stray light graph. FIG. 8 shows an example demonstrating the feasibility of the stray-light collimator. FIG. 8a shows the impact of back-reflected light on a cylinder phantom surface. FIG. 8b Collimator reduces back-reflected light. (c) Cross-section (----) of light intensity along cylinder surface.

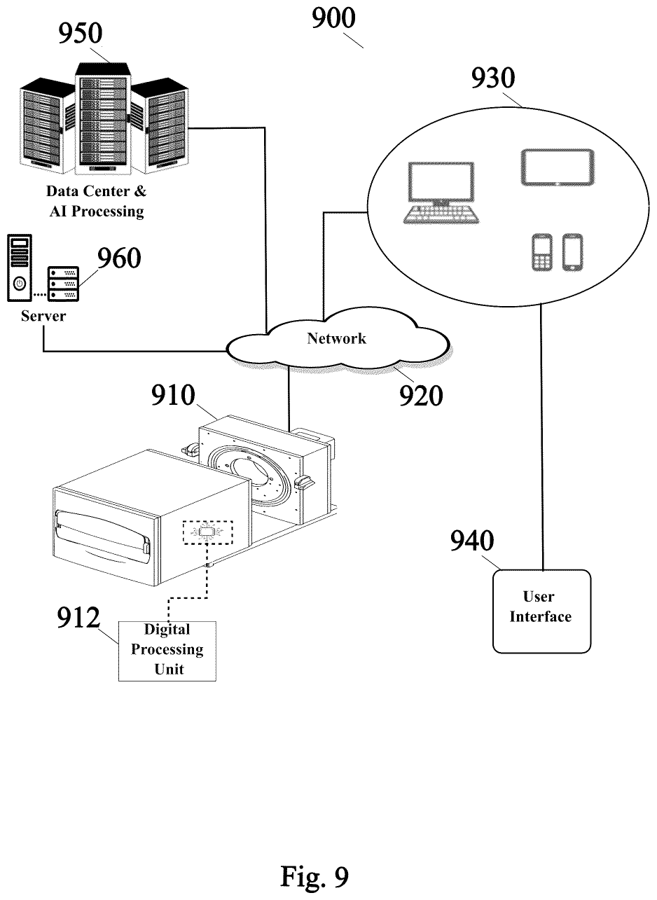

FIG. 9 illustrates a network diagram of the platform for preclinical optical imaging. The network diagram 900 illustrates one embodiment of a networked data center and AI processing service integrated with the platform for preclinical imaging. The network 900 may include an imaging device 910 equipped with a digital processing unit or processor, a network 920, a plurality of user devices 930 (e.g., laptop, desktop, tablet and mobile device), a user interface 940, a data center/artificial intelligence processing service 950 and a server.

In one embodiment, the server, data center and AI processing service are communicatively coupled to network 920. The imaging device 910 is also coupled to the network 920, and the digital processing unit 912 executes instructions and/or provides control signals from a user interface 940 via a user device 930 to the device 910. The user devices (e.g., laptop, desktop computer, smartphone, tablet) and the user interface unit 940 are likewise communicatively coupled to the network 920.

The digital processing unit 912 may control the processing instructions executed by the preclinical imaging device and/or platform 910. Its functions include controlling the device to perform specific imaging techniques, such as Bioluminescence Imaging (BLI) and Cerenkov Light Imaging (CLI). It manages the image acquisition process, potentially involving semi-automated procedures and initial image processing steps like deconvolution to optimize image quality. The unit ensures that data congruency is maintained, potentially by co-registering images to a statistical animal atlas. The processed or raw image data is then prepared for transmission over the network 920 to a user device, server and/or data center for additional processing.

In one embodiment, the data center/AI processing service may include the training and utilization of Convolutional Neural Networks (CNNs) for image segmentation, noise reduction, resolution enhancement, and feature extraction from the images. For example, One-Dimensional CNNs (1DCNNs) may be used in bioluminescence tomography (BLT) to establish a non-linear mapping between surface photon flux density and the internal light source distribution, addressing the ill-posed inverse problem of 3D reconstruction. The data center may also utilize Image Segmentation Models like U-Net to precisely delineate relevant structures, such as organs or tumors, in the BLI/CLI images. In one implementation, a Self-supervised Hybrid Neural Networks may integrate physical models of light propagation to achieve quantitative reconstruction, especially when labeled training data is limited. Other implementations may also utilize Transfer Learning Models which may include a pre-trained network like ResNet or VGG and then may be fine-tuned on the preclinical imaging data to achieve high classification accuracy with smaller datasets.

Single-View Transillumination Module: Designed for planar high-throughput fluorescence imaging (FLI) and diffuse optical imaging (DOI), it incorporates an imaging stage for holding fluorescence objects or up to five animals, and a single planar mirror for reflecting light into the camera.

Multi-View Transillumination Module: This module enhances the platform's capabilities by enabling 3D fluorescence tomography and diffuse optical tomography (DOT). Its mirror-based multi-view trans-illumination design contributes to the comprehensive understanding of fluorescent-labeled targets within animals. It also enables the reconstruction of absorption and scattering properties and, thus, provides detailed 3D spatial maps of blood volume and hemoglobin oxygenation levels in mice, e.g. relevant in tumor, brain, or cardiovascular imaging.

The multi-view module for BLI and CLI capitalizes on several innovative components, including an advantageous MA method, featuring a concentric mirror system and an advantageous stray-light collimator (SLC), that can significantly increase imaging sensitivity and reduces the impact of stray light. It collects more photons, improves the signal-to-noise ratio (SNR), enables multi-view imaging, and can provide 3D tomographic data sets in less time than any optical system with comparable camera and lens system. The two key innovations of the multi-view detector head are multiple apertures and stray-light collimator.

The MA method utilizes a concentric system of N planar mirrors to significantly boost the total light collection capabilities of the optical train. N/2 mirrors of the concentric system can collect photons from a single surface point within solid angles Ωn but from different viewing angles ωn. Combining all solid angles increases the total light collection capability or total aperture of the optical train by a factor N/2. Thus, it increases the SNR of the camera image by a factor N/\sqrt{2N}. Hence, a 12-mirror system increases the SNR by a factor of 2.4. In practice, the animal inside the optically transparent BCAM is placed in the center of the mirror system and without obstructing any view. Emitted light is reflected into the camera, while providing different views of the same surface point. A back-projection algorithm maps the camera image back onto the BCAM while integrating the light intensities of each mirror segment for each surface point. The increased total flux and SNR enable imaging of smaller or deep-seated optical reporters and facilitates tomographic imaging with narrow bandpass filters. The mirror system also provides a complete view of the entire animal surface. In comparison, most commercially available preclinical imaging systems only use a single view or solid angle, and their imaging sensitivity is solely dependent on the optical performance of camera and lens.

The Stray-Light Collimator (SLC) is a device that restricts the acceptance angle of emitted photons that strike the mirror surface and prevents photons from being reflected again to the animal surface. It reduces the amount of back-reflected light that could interfere with the measured optical signal. The cylindrical SLC consists of a stack of thin, black-coated metal rings, held together by vertical metal stripes. The BCAM with animal is placed inside the SLC. The ring dimensions are deliberately chosen according to the acceptance angle for photons striking the mirror into the camera, whereas back-reflected photons will be absorbed by the metal. The SLC eliminates the challenges of back-reflection encountered in mirror-based systems, specifically for conical mirror systems. It has been reported that conical mirrors can add up to 20% of the optical signal back to the animal surface and contribute to the total signal measured by the camera, while decreasing its SNR. Therefore, the proposed SLC can make mirror-based systems a viable solution for multi-view imaging.

The present invention is described in the following Examples, which are set forth to aid in the understanding of the invention and should not be construed to limit in any way the scope of the invention as defined in the claims which follow thereafter.

### EXAMPLES

### Example 1

We investigated the total light collection capabilities of a concentric mirror system and the impact of a stray-light collimator (SLC) in reducing unwanted back-reflection (FIG. 5). The proposed imaging system (FIG. 5A) consisted of the BCAM with adapter for secure placement, a gantry with 12 concentric planar mirror segments, a SLC, lens (f=25 mm, f/0.95), and a 13.4×13.4 mm² sensor area. Each of the 12 mirror segments had a size of 32 mm×140 mm, placed in a concentric arrangement (inner ø50 mm, outer ø250 mm, 45° mirror segment tilt) around the BCAM. Next, we performed a simulation study based on the CAD model using the ray-tracing software Zemax®. We placed a uniform Lambertian emitter (ø10 mm) and known intensity at three different locations on the BCAM surface and calculated the amount of light that strikes the mirrors and is reflected onto the sensor (FIG. 5B&C). Lastly, we estimated the amount of stray light being reflected onto the BCAM surface with or without collimator. We found a linear dependence of the impact of back-reflection as a function of the inner diameter of the concentric mirror system. An increase in inner diameter decreases the amount of back-reflected light.

We have built a prototype of a mirror system based on the CAD model in FIG. 5A. The system consists of 12 concentrically aligned planar mirror segments (98% reflection, FOV ø250 mm). A BCAM with animal (FIG. 3C & FIG. 7) or a cylinder phantom (FIG. 6) can be placed in its center axis and is held by the tail support of the BCAM and the gas anesthesia port. It provides an unobstructed 360° view of the entire BCAM or phantom surface. Imaging was performed using a 25 mm f/ 0.95 lens (Schneider) and CCD camera (Raptor Eagle 1M). In vivo results are shown in FIG. 7.

We conducted comprehensive MA validation experiments involving the 12× mirror system (FIG. 4A & FIG. 6A), collimator prototype (FIG. 4B), and a simple MA back-projection algorithm. A Python-based back-projection algorithm was developed to calculate the total light intensity on a cylindrical object surface (FIG. 6C), leveraging all mirror segments (FIG. 6A & B). Subsequently, a 3D-printed cylindrical phantom (ø30 mm) housing tritium light sources along its center axis was positioned within the mirror system. The tritium light sources generated a uniform light distribution on the phantom surface, and image recording was performed using a 25 mm f/0.95 lens (Schneider) and CCD camera (Raptor Eagle 1M) to evaluate the MA performance. The SNR increased by a factor of 2.4 (FIG. 6E) in accordance with theory (FIG. 6D).

### Example 2

We investigated the impact of a SLC in reducing unwanted back-reflection. We built a SLC prototype (FIG. 4B) consisting of 12 baffles along its cylindrical axis and 17 cylindrical baffles perpendicular to it, both made of painted-black sheet metal of 0.8 mm thickness. Imaging was performed using a 25 mm f/0.95 lens (Schneider) and CCD camera (Raptor Eagle 1M) to evaluate the SLC performance (FIG. 8H). The impact of the SLC on the uniform surface light distribution is shown in FIG. 8G versus no SLC (FIG. 8F).

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A platform for preclinical optical imaging, comprising:
an optically sealed container housing an optical camera, a fan, and a filter wheel with a plurality of bandpass filters;
an interchangeable detector head module; and
a digital processing unit.

2. The platform of claim 1, further comprising:
an imaging stage holding a plurality of imaging subjects; and
wherein the interchangeable detector head module includes a single view base module having a planar mirror reflecting light into the optical camera.

3. The platform of claim 2, further comprising:
an imaging stage holding a plurality of imaging subjects; and
wherein the interchangeable detector head module includes a dual view base module having at least two planar mirrors simultaneously capturing a dorsal view, a ventral view, a lateral left view and a lateral right view of the plurality of imaging subjects.

4. The platform of claim 3, further comprising:
a body conforming animal mold holding each of the plurality of imaging subjects.

5. The platform of claim 4, further comprising:
an organ probability map utilized in combination with the body conforming animal mold to achieve anatomical co-registration.

6. The platform of claim 1, further comprising:
a multiple view base module having a plurality of apertures, the plurality of apertures proportionally improving a signal to noise ratio;
a concentric planar mirror system;
a stray-light collimator; and
a body conforming animal mold.

7. The platform of claim 6, wherein the plurality of apertures proportionally improves the signal to noise ratio is improved by a factor of √N, where N is a numerical sum of the plurality of apertures.

8. The platform of claim 6, wherein the optical camera and concentric mirror system are in a fixed position.

9. The platform of claim 6, wherein the concentric planar mirror system includes a plurality of segments wherein a number of segments increases a total light collection capability.

10. The platform of claim 9, wherein the stray-light collimator is cylindrical in shape and reduces an amount of back-reflected light.

11. A method for preclinical optical imaging, comprising:
providing an optically sealed container housing an optical camera, a fan, and a filter wheel with a plurality of bandpass filters;
providing an interchangeable detector head module;
initializing a digital processing unit for performing imaging techniques of one or more imaging subjects; and
capturing an image of the imaging subject.

12. The method of claim 11, further comprising:
selecting a 2D imaging modality with a single view base module; and
performing the 2D imaging modality with the single view base module.

13. The method of claim 11, further comprising:
selecting a 3D imaging modality with a multiple view base module;
performing the 3D imaging modality with the multiple view base module.

14. The method of claim 11, further comprising:
selecting, via the digital processing unit, an imaging mode from a plurality of imaging modes.

15. The method of claim 11, wherein the imaging modes include bioluminescence imaging (BLI), fluorescence imaging (FLI), and Cerenkov light imaging (CLI).

16. The method of claim 11, further comprising:
configuring a mirror system to capture a plurality of views of an imaging subject;
increasing a total aperture by combining a plurality of apertures;
enhancing imaging sensitivity with a stray light collimator.

17. The method of claim 11, further comprising:
presenting a user interface on a device providing for engagement with interchangeable detector head module.

18. The method of claim 11, further comprising:
reconstructing a 3D spatial distribution of one or more optical reporters with a multispectral optical tomography technique.

19. The method of claim 18, wherein the multispectral optical tomography technique is bioluminescence tomography.

20. The method of claim 18, wherein the multispectral optical tomography technique is Cerenkov light tomography.
